(19) United States
(12) Patent Application Publication
(10) Pub. No.: US 2008/0073026 A1
(43) Pub. Date: Mar. 27, 2008

(54) Method of supplying liquid bonding material, method of manufacturing electronic circuit board, liquid bonding material supply apparatus and liquid bonding material

(75) Inventors: Junichi Yoshida, Kanagawa-ken (JP); Seiichi Inoue, Kanagawa-ken (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/902,598

(22) Filed: Sep. 24, 2007

(30) Foreign Application Priority Data
Sep. 25, 2006 (JP) 2006-259656

(51) Int. Cl. B29C 65/14; B05D 1/26; C08K 3/10

(52) U.S. Cl. 156/273.3; 156/379.6; 427/475; 524/403; 524/430

(57) ABSTRACT

The method of supplying a liquid bonding material includes the steps of: preparing a liquid bonding material containing an insulating solvent and charged particles dispersed in the insulating solvent, the charged particles being constituted by metal particles and an insulating resin material that coats the metal particles and takes charge; and condensing and supplying the liquid bonding material by means of an electrostatic force generated between a supply side and a supply receiving side for the liquid bonding material.

### BACKGROUND OF THE INVENTION

1. Field of the Invention

The present invention relates to a method of supplying a liquid bonding material, a method of manufacturing an electronic circuit board, a liquid bonding material supply apparatus and a liquid bonding material, whereby liquid bonding material can be supplied while preventing overspill caused by wetting and spreading of the material, even if the locations to which the liquid bonding material are to be supplied are very small in size.

2. Description of the Related Art

The method of manufacturing an electronic circuit substrate used in electronic equipment involves a process in which electronic components are installed on a substrate, and more particularly, a process in which prescribed locations of electronic components (for example, electrodes, leads, terminals, or the like; hereinafter called “electrode”) and prescribed locations of wires formed in an electronic circuit substrate (for example, lands, pads, or the like; hereinafter called “land”), are bonded together electrically and physically.

In this process, generally, a screen printing method is used to supply a bonding material. More specifically, using a screen printing method, a cream solder forming a bonding material is printed onto the lands of wires formed on the electronic circuit substrate, electronic components are arranged (hereinafter, “mounted”) appropriately by a mounting apparatus, in such a manner that the electrodes of the electronic components are positioned on the cream solder, and in this state, thermal processing (so-called “reflow heating”) is carried out.

However, due to the requirement in recent years for further compactification and greater functionality in portable electronic equipment, such as portable telephones, integration has been raised to higher levels in the electronic circuit substrates installed in portable electronic equipment of this kind, and therefore the electronic components used have become progressively smaller in size and the pitch between electrodes has become progressively narrower. Consequently, it has become necessary to supply bonding material onto lands of very small size, in other words, to achieve even finer definition in the bonding patterns formed by bonding material. If a screen printing method as described above is used to supply cream solder to very small lands of the wires on an electronic circuit substrate of this kind, then problems of deterioration in quality arise, such as screen separation errors, thin spots, insufficient deposition of cream solder, or the like. Therefore, instead of a screen printing method, bonding material supply methods have been proposed which use the principles of an inkjet printing method (an image recording method which ejects ink onto a recording medium from nozzles), or an electrophotographic method (a dry image recording method in which a toner is distributed onto a photosensitive body and then transferred to a recording medium by means of a photoconductive effect and electrostatic attraction.)

Japanese Patent Application Publication No. 2004-74267 describes supplying a liquid bonding material, formed by coating metal particles in a resin material and dispersing same in a dispersion medium, onto lands on an electronic circuit substrate, by using the principles of an inkjet recording method. It also describes an example which uses a so-called solid ink type of bonding material, in other words, a bonding material which has no fluidity in a normal state (for example, 5 to 50° C.), but which becomes a liquid at high temperature (for example, 100 to 160° C.).

Furthermore, Japanese Patent Application Publication No. 2003-168324 describes supplying charged particles in the form of solid powder (particles formed by coating metal particles with an insulating resin material and charging the particles), onto lands of an electronic circuit substrate, by using the principles of an electrophotographic technique.

The technology described in Japanese Patent Application Publication No. 2004-74267 involves a problem in that when liquid bonding material is ejected onto very small lands on the electronic circuit substrate, the liquid bonding material wets and spreads on the lands and spills out beyond the lands.

In particular, in order to achieve a reliable bond between the lands and the electrodes of the electronic components, it is necessary to supply (print) the liquid bonding material in a superimposed fashion onto the lands; however, if liquid bonding material is supplied in a superimposed fashion on the lands in this way, then the amount of liquid bonding material supplied per land increases, and therefore the problem described above becomes more pronounced.

More specifically, a desirable thickness of the liquid bonding material on the lands is generally 30 to 100 μm, but in order to achieve a thickness of this kind, it is necessary to print superimposed layers, either by passing the electronic circuit substrate through a plurality of printing apparatuses, or by passing the electronic circuit substrate a plurality of times through the same printing apparatus. In so doing, in the case of very small lands, liquid bonding material spills out beyond the lands due to the wetting and spreading of the liquid bonding material.

When a so-called solid ink type of bonding material is supplied by ejection onto lands by means of a liquid ejection head, it is necessary to heat the solid ink type of bonding material to transform same into a liquid state for ejection, to a temperature (approximately 100 to 160° C.) that is higher than that of a so-called liquid ink type of bonding material, and therefore the constituent materials of the liquid ejection head must have heat resistant properties (generic engineering plastic materials cannot be used). Furthermore, since a solid ink type of bonding material solidifies due to cooling or heat radiation after being supplied to the substrate, the heat radiation effects vary with the size of the lands (due to the difference in the amount of bonding material supplied), and consequently, the viscosity varies between different locations (there is a difference in hardness), and when mounting the electronic components, there is a difference in the adhesive characteristics of the electronic components, which presents an obstacle to the mounting process. Moreover, since the solid ink type of bonding material solidifies due to cooling or heat radiation after being supplied to the substrate, then a longer time is required for solidification in regions where the size of the lands is large, thus leading to a decline in productivity. As a device for avoiding these problems, in practice, it is necessary to heat the substrate previously to a degree whereby the bonding material assumes a semi-molten state, but this requires the additional provision of a substrate heating apparatus, temperature control apparatus, and the like, and consequently causes apparatus costs to increase. Moreover, similarly to a liquid ink type of bonding material, it is desirable to print in a superimposed fashion, but if the amount of bonding material is increased, then this results in the aforementioned problems becoming even more pronounced. In other words, if printing in a superimposed fashion in order to print a suitable amount of bonding material onto the lands, in the case of a liquid ink type of bonding material, the wetting and spreading of the bonding material becomes more pronounced. In the case of a solid ink type of bonding material, in addition to the temperature control of the bonding material during printing, more precise and complicated temperature control of the substrate, and the like, is required in order to achieve uniform viscosity of the bonding material, regardless of the printing location. Therefore, it is extremely difficult to accumulate layers of the bonding material. Moreover, needless to say, it is also difficult to accumulate layers of bonding material while maintaining the size (dot diameter) in the direction of lamination. There is also a problem in that nozzle blockages are caused by the high-viscosity bonding material before heating of the ejection head. In other words, it is not easy to supply a solid ink type of bonding material to the substrate.

Furthermore, the technology described in Japanese Patent Application Publication No. 2003-168324 uses the principle of an electrophotographic technique, in other words, it is necessary to distribute a bonding material in the form of a solid powder onto a photosensitive body and then transfer same to the lands of an electronic circuit substrate, by means of a photoconductive effect and electrostatic attraction, and therefore a special light irradiation step and transfer step are required. Consequently, the apparatus increases in size, productivity declines, and costs rise.

### SUMMARY OF THE INVENTION

The present invention has been contrived in view of the foregoing circumstances, an object thereof being to provide a method of supplying a liquid bonding material, a method of manufacturing an electronic circuit substrate, a liquid bonding material supply apparatus and a liquid bonding material, whereby liquid bonding material can be supplied readily without causing overspill due to wetting and spreading, even if the locations to which the liquid bonding material is to be supplied are very small in size.

In order to attain the aforementioned object, the present invention is directed to a method of supplying a liquid bonding material, comprising the steps of: preparing a liquid bonding material containing an insulating solvent and charged particles dispersed in the insulating solvent, the charged particles being constituted by metal particles and an insulating resin material that coats the metal particles and takes charge; and condensing and supplying the liquid bonding material by means of an electrostatic force generated between a supply side and a supply receiving side for the liquid bonding material.

In this aspect of the present invention, the liquid bonding material is condensed for supply by means of an electrostatic force generated between the supply side and the supply receiving side for the liquid bonding material, and consequently there is no overspill of the liquid due to wetting and spreading even if the supply receiving location for the liquid bonding material is very small in size. Moreover, since heating is not required on the bonding material supply side, then in contrast to a case where a so-called solid ink type of bonding material is supplied by being heated to a high temperature (approximately 100 to 160° C.), the constituent material of the bonding material supply side is not required to have heat resistant properties, and therefore costs are reduced. Furthermore, since a light irradiation step and a transfer step are not required, in contrast to a case where an electrophotographic technique is used, then it is possible to reduce the size of the apparatus composition on the bonding material supply side and to ensure high productivity and reduced costs.

In order to attain the aforementioned object, the present invention is also directed to a method of manufacturing an electronic circuit substrate, comprising the steps of: preparing a liquid bonding material containing an insulating solvent and charged particles dispersed in the insulating solvent, the charged particles being constituted by metal particles and an insulating resin material that coats the metal particles and takes charge; condensing the liquid bonding material and supplying the liquid bonding material to a supply receiving location of a substrate, by means of an electrostatic force generated between a liquid supply apparatus supplying the liquid bonding material and the supply receiving location of the substrate by the liquid supply apparatus; arranging an electrode of an electronic component on the supply receiving location of the substrate; and causing the insulating resin material and the metal particles of the liquid bonding material supplied to the supply receiving location of the substrate to melt, wherein the supply receiving location of the substrate and the electrode of the electronic component are bonded electrically and physically.

Preferably, the supply receiving location of the substrate is a land of the substrate.

Preferably, the liquid bonding material is ejected onto the land a plurality of times in such a manner that the charged particles are accumulated on the land.

Preferably, the liquid bonding material is supplied to the land according to electronic circuit substrate manufacturing data which includes, at least, positional information relating to the land of the substrate.

In order to attain the aforementioned object, the present invention is also directed to a liquid bonding material supply apparatus which supplies a liquid bonding material to a supply receiving body, wherein: the liquid bonding material contains an insulating solvent and charged particles dispersed in the insulating solvent, the charged particles being constituted by metal particles and an insulating resin material that coats the metal particles and takes charge; and the liquid bonding material is condensed and supplied to the supply receiving body by means of an electrostatic force generated between the liquid bonding material supply apparatus and the supply receiving body.

In order to attain the aforementioned object, the present invention is also directed to a liquid bonding material which is condensed and supplied to a supply receiving side by means of an electrostatic force generated between a supply side and the supply receiving side, the liquid bonding material containing an insulating solvent and charged particles dispersed in the insulating solvent, the charged particles being constituted by metal particles and an insulating resin material that coats the metal particles and takes charge.

Preferably, the metal particles are made of a metal material selected from the group consisting of an Sn—Pb material, an Sn—Ag material, an Sn—Ag—Cu material, an Sn—Bi material, an Sn—Cu material, an Sn—Cu—Ni material, an Sn—Ag—Bi material, an Sn—Ag—Bi—In material, an Sn—Ag—Bi—Cu material, an Sn—Zn material, and an Sn—Zn—Bi material.

Preferably, the insulating resin material includes at least one of an antioxidant component and an adhesive component.

Examples of the insulating resin material used may include rosin which has antioxidant and adhesive properties.

The insulating solvent used is a dielectric solvent having high electrical resistivity which is 10⁹ Ω·cm or greater, and more desirably, 10¹⁰ Ω·cm or greater. Furthermore, the dielectric constant of the insulating solvent is desirably 5 or lower, and more desirably, 4 or lower, and even more desirably, 3.5 or lower.

According to the present invention, it is possible to supply liquid bonding material readily, without giving rise to overspill due to wetting and spreading, without using a solid ink type of bonding material of an electrophotographic technique, even if the liquid bonding material supply receiving location is very small in size.

### BRIEF DESCRIPTION OF THE DRAWINGS

The nature of this invention, as well as other objects and benefits thereof, will be explained in the following with reference to the accompanying drawings, in which like reference characters designate the same or similar parts throughout the figures and wherein:

FIG. 1A is a schematic drawing showing the principal part including a liquid ejection head in a liquid bonding material apparatus according to an embodiment of the present invention; and FIG. 1B is a view along line IB-IB in FIG. 1A;

FIG. 2 is a schematic drawing showing an aspect of the two-dimensional arrangement of a plurality of ejection ports in an ejection port substrate of the liquid ejection head;

FIG. 3 is a schematic drawing showing the planar structure of a guard electrode in the liquid ejection head;

FIG. 4A is a partial cross-sectional perspective diagram showing the composition in the vicinity of an ejection port in the liquid ejection head, and FIG. 4B is an illustrative diagram used to describe the shape and dimensions of liquid guide dams;

FIGS. 5A to 5F are schematic drawings showing examples of the shapes of various types of ejection electrode;

FIGS. 6A and 6B are illustrative diagrams used to describe a liquid bonding material relating to an embodiment of the present invention;

FIG. 7 is a block diagram showing a bonding apparatus including a liquid ejection apparatus forming a liquid bonding material supply apparatus according to an embodiment of the present invention; and

FIGS. 8A to 8E are step diagrams used to describe one example of a method of manufacturing an electronic circuit substrate relating to an embodiment of the present invention.

### DETAILED DESCRIPTION OF THE PREFERRED EMBODIMENTS

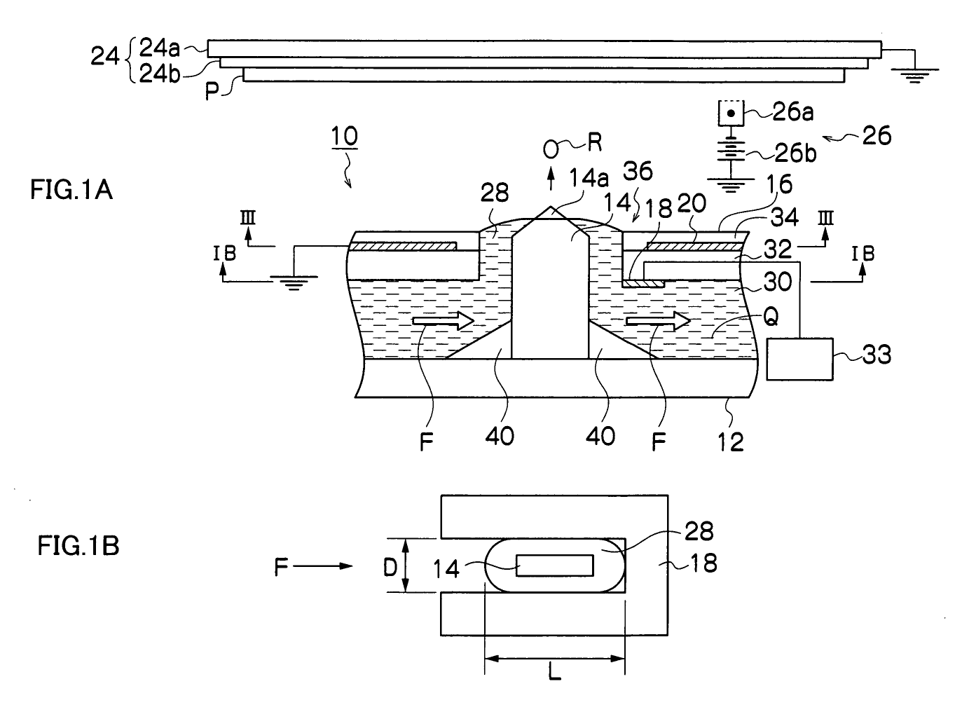

FIG. 1A is a schematic cross-sectional drawing showing the general composition of a liquid ejection head, and the peripheral region of same, which constitutes the principal part of the liquid bonding material supply apparatus according to the present invention. FIG. 1B shows a view along the arrow IB-IB in FIG. 1A.

As shown in FIG. 1A, the liquid ejection head 10 comprises a head substrate 12, a liquid guide 14, and an ejection port substrate 16 formed with an ejection port 28. An ejection electrode 18 is provided in the ejection port substrate 16 so as to surround the ejection port 28.

A substrate holding section 24 which holds an electronic circuit substrate P, and a charging unit 26 for the electronic circuit substrate P are disposed at positions opposing the ejection side surface (in FIG. 1A, the upper surface, of the liquid ejection head 10)

The head substrate 12 and the ejection port substrate 16 are disposed so as to face each other at a prescribed interval apart. A liquid flow channel 30 for supplying a liquid bonding material (hereinafter, called “bonding liquid”) Q to the ejection ports 28 is formed in the space created between the head substrate 12 and the ejection port substrate 16. The bonding liquid Q flowing in the liquid flow channel 30 is guided toward each ejection port 28 by means of a liquid guide 14, and energy is applied to the liquid by means of the ejection electrode 18, thereby condensing the liquid, which is ejected from the ejection port 28 toward the electronic circuit substrate P and is thus supplied to the electronic circuit substrate P.

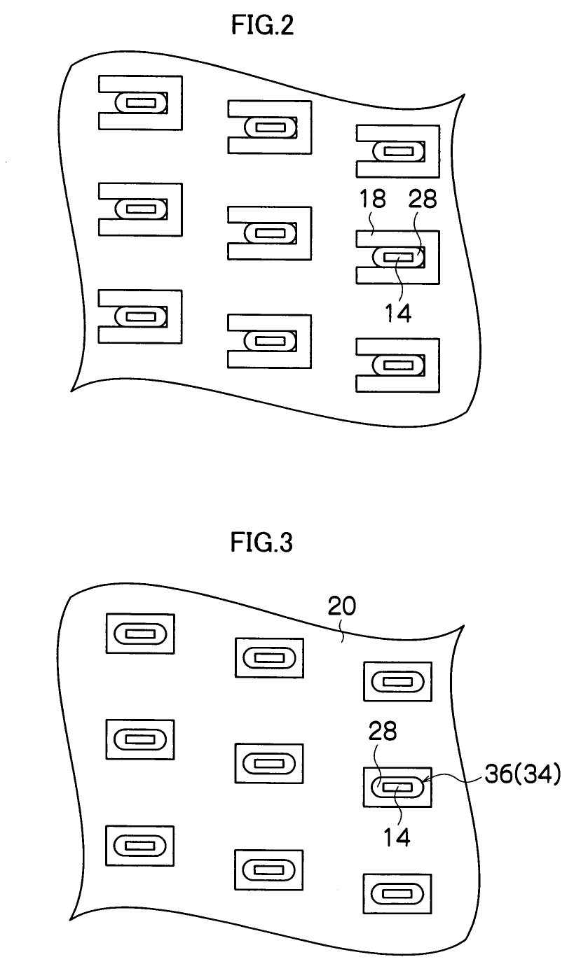

In order to achieve a fast and accurate supply of bonding liquid Q to the electronic circuit substrate P, the liquid ejection head 10 has a multiple-channel structure in which a plurality of ejection ports 28 (nozzles) are arranged in a two-dimensional configuration. FIG. 2 shows a schematic view of a case where a plurality of ejection ports 28 are arranged two-dimensionally in the ejection port substrate 16 of the liquid ejection head 10. In FIGS. 1A and 1B, only one ejection port of the plurality of ejection ports 28 is depicted, in order that the composition of the liquid ejection head 10 can be readily understood.

In the liquid ejection head 10, the number of ejection ports 28 and their physical arrangement pattern, and the like, can be selected freely. For example, rather than the multi-channel structure shown in FIG. 2, it is also possible to provide only one row of ejection ports. Furthermore, it is also possible to use a so-called (full) line head having a row of ejection ports corresponding to the full range of the electronic circuit substrate P, or a so-called serial head (shuttle type of head), which scans (moves) in a direction perpendicular to the direction of the nozzle rows.

FIG. 2 shows the arrangement of ejection ports 28 in one portion (3 rows and 3 columns) of the multiple-channel structure, and in a desirable mode, the ejection ports 28 in a row on the downstream side, in terms of the direction of flow F of the bonding liquid Q which flows in the liquid flow channel 30 (hereinafter, called “liquid flow direction F”), are staggered by a prescribed pitch in the direction perpendicular to the liquid flow direction F, with respect to the ejection ports 28 in the row to the upstream side. In this way, by providing the ejection ports 28 in a row on the downstream side in positions which are staggered in the direction perpendicular to the liquid flow direction F with respect to ejection ports 28 in the row to the upstream side thereof, it is possible to achieve a good supply of bonding liquid Q to the ejection ports 28. The composition of the liquid ejection head 10 may be based on an arrangement of ejection ports 28 in n rows and m columns (where n and m are positive integers), disposed in a configuration where the ejection ports 28 in a row on the downstream side are staggered in position in the direction perpendicular to the liquid flow direction F with respect to the ejection ports 29 of the row to the upstream side, this n-row and m-column arrangement being repeated continuously at a uniform cycle in the liquid flow direction F, or alternatively, the ejection ports 28 may be arranged in a continuously staggered configuration in a single direction perpendicular to the liquid flow direction F (the downward direction or the upward direction in FIG. 2), with respect to the ejection ports 28 positioned to the upstream side thereof. The number of ejection ports 28, their pitch and repetition cycle, and the like, can be set appropriately in accordance with the resolution and conveyance pitch.

Furthermore, in FIG. 2, a desirable mode is depicted as one in which the ejection ports 28 in a row on the downstream side in terms of the liquid flow direction F are staggered in position in the direction perpendicular to the liquid flow direction F, with respect to the ejection ports 28 in the row to the upstream side, but the invention is not limited to this. It is also possible for the ejection ports 28 on the downstream side and the ejection ports 28 on the upstream side to be arranged on the same straight line in the liquid flow direction F. In this case, desirably, the ejection ports 28 in each of the columns are arranged in positions which are staggered in the liquid flow direction F with respect to the respective ejection ports 28 in the columns that are adjacent in the direction perpendicular to the liquid flow direction F.

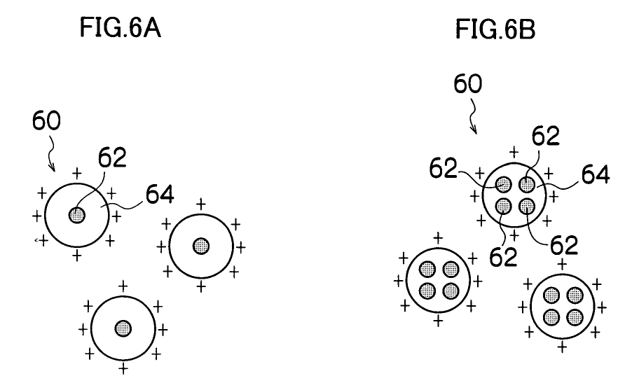

In a liquid ejection head 10 of this kind, a bonding liquid Q is used in which charged particles (60 in FIGS. 6A and 6B) described below are dispersed in an insulating liquid medium (hereinafter, called “carrier liquid”).

A drive voltage is applied to the ejection electrodes 18 provided on the ejection port substrate 16 shown in FIGS. 1A and 1B, thereby generating an electric field at each ejection port 28, and the bonding liquid Q inside each ejection port 28 is condensed and ejected due to the resulting electrostatic force. Furthermore, by switching the drive voltage applied to the ejection electrodes 18, on and off (ejection on/off) on the basis of electronic circuit substrate manufacturing data, bonding liquid droplets R corresponding to the electronic circuit substrate manufacturing data are ejected from the ejection ports 28, whereby bonding liquid Q is supplied to the electronic circuit substrate P.

Below, the structure of the liquid ejection head 10 shown in FIGS. 1A and 1B is described in detail.

As shown in FIG. 1A, the ejection port substrate 16 of the liquid ejection head 10 comprises an insulating substrate 32, a guard electrode 20, an ejection electrode 18, and an insulating layer 34. The guard electrode 20 and the insulating layer 34 are layered successively onto the upper surface of the insulating substrate 32 (the upper surface in FIG. 1A, in other words, the surface opposite to the surface facing the head substrate 12). Furthermore, the ejection electrode 18 is formed on the lower surface of the insulating substrate 32 (the lower surface in FIG. 1A, in other words, the surface on the side facing the head substrate 12).

Moreover, in the ejection port substrate 16, the ejection ports 28 for causing bonding liquid Q to be ejected in the form of a bonding liquid droplet R are formed passing through the insulating substrate 32. As shown in FIG. 1B, each ejection port 28 is a cocoon-shaped opening (slit) which extends in the liquid flow direction F, the shorter edges at either end of the rectangular shape being formed in a semi-circular shape. The aspect ratio (L/D) between the length L thereof in the liquid flow direction F and the length D in the direction perpendicular to the liquid flow direction is equal to or greater than 1.

In this way, by forming the ejection ports 28 as openings having an aspect ratio (L/D) equal to or greater than 1 between the length L in the liquid flow direction F and the length D in the direction perpendicular to the liquid flow direction F (an anisotropic shape having longer edges in the liquid flow direction F; namely, an elongated shape having longer edges in the liquid flow direction F), the bonding liquid Q becomes more liable to flow to the ejection ports 28. In other words, it is possible to improve the supply of the particles of the bonding liquid Q to the ejection ports 28, and therefore the frequency response is further improved and blockages can be prevented.

In the present embodiment, the ejection ports 28 are formed as elongated cocoon-shaped openings, but the shape is not limited to this and it is also possible to form the ejection ports of any desired shape, such as a substantially circular shape, an elliptical shape, a rectangular shape, a rhomboid shape, a parallelogram shape, or the like, provided that the ejection ports are capable of ejecting bonding liquid droplets R and have an aspect ratio equal to or greater than 1 between the length in the liquid flow direction F and the length in the direction perpendicular to the liquid flow direction F. For example, it is possible to adopt a rectangular shape having longer edges in the liquid flow direction F, or an elliptical or rhomboid shape having a long axis in the liquid flow direction F. Furthermore, it is also possible to form the ejection ports in a trapezoid shape in which the upstream side in terms of the liquid flow direction F is taken as the upper base, the downstream side is taken as the lower base, and the height in the liquid flow direction F is greater than the length of the lower base. In this case, it is also possible to make the edge on the upstream side longer, or to make the edge on the downstream side longer. Moreover, it is also possible to adopt a shape comprising a rectangular shape having longer edges in the liquid flow direction F, with a large circle having a diameter larger than the shorter edges of the rectangular shape being attached to both of the shorter edges of the rectangular shape. Furthermore, the ejection ports may be symmetrical on the upstream side and the downstream side of their center, or they may be asymmetrical. For example, it is also possible to form ejection ports in which at least one of the end sections on either the upstream side or the downstream side of a rectangular ejection port is formed with a semi-circular shape.

The liquid guides 14 of the liquid ejection head 10 are made of ceramic flat plates having a prescribed thickness and are disposed on the head substrate 12 so as to correspond to the respective ejection ports 28. The liquid guides 14 are each formed to have a slightly broadened shape in accordance with the length of the cocoon-shaped ejection ports 28 in the direction of the longer dimension. As stated previously, the liquid guides 14 passes through the respective ejection ports 28 and the front end portions 14a thereof project above the surface of the ejection port substrate 16 on the side adjacent to the electronic circuit substrate P (the front surface of the insulating layer 34).

The front end portion 14a of each liquid guide 14 is formed in a substantially triangular shape (or a trapezoid shape) which gradually narrows towards the side of the substrate holding section 24. Each liquid guide 14 is disposed in such a manner that the inclined surface of the front end portion 14a intersects with the liquid flow direction F. By this means, the bonding liquid Q flowing into the ejection port 28 passes along the inclined surfaces of the front end portion 14a of each liquid guide 14 until reaching the apex of the front end portion 14a, and therefore the bonding liquid Q forms a stable meniscus in the ejection port 28.

Furthermore, by forming the liquid guides 14 to be broadened in the lengthwise direction of the ejection ports 28, it is possible to shorten the width thereof in the direction perpendicular to the liquid flow direction F, and therefore the effect of the ejection guides 14 on the flow of bonding liquid Q can be reduced, while also forming a stable meniscus, as described below.

The shape of the liquid guides 14 can be changed suitably, provided that the liquid guides 14 enable the charged particles in the bonding liquid Q to be condensed at the front end portions 14a through the ejection ports 28 in the ejection port substrate 16, and there are no particular restrictions on the shape of the liquid guides 14. For instance, the liquid guides 14 may be shaped in such a manner that the front end portions 14a narrow toward the side of the substrate holding section 24. For example, it is also possible to form a cutaway section in the central portion of each liquid guide 14, thereby creating a liquid guide groove which gathers the bonding liquid Q to the front end portion 14a by means of a capillary action acting in the vertical direction in the drawing.

Furthermore, desirably, metal is deposited by vapor deposition onto the endmost tip portion of each liquid guide 14. By vapor depositing metal onto the endmost tip portion of each liquid guide 14, the dielectric constant of the front end portion 14a of each liquid guide 14 is raised substantially. Consequently, a strong electrical field can be generated readily, and the ejection characteristics of the bonding liquid Q can be improved.

As shown in FIG. 1A, the ejection electrodes 18 are formed on the lower surface of the insulating substrate 32 (namely, on the surface facing the head substrate 12). The ejection electrodes 18 are disposed in a square U shape following the perimeter edge of the ejection ports 28, with the edge on the upstream side in terms of the liquid flow being cut away, and the ejection electrodes 18 thereby surround the perimeter edge of the rectangular ejection port 28. In FIG. 1B, each ejection electrode 18 is formed in a square U shape, but it may be formed to any shape provided that it is disposed so as to border onto the liquid guide 14, for example, the ejection electrodes 18 may be altered to a variety of different shapes, in accordance with the shape of the ejection ports 28, such as a square electrode, a ring-shaped circular electrode, an elliptical electrode, a split circular electrode, a parallel electrode, a substantially parallel electrode, or the like.

As stated previously, since the liquid ejection head 10 has a multiple-channel structure in which the ejection ports 28 are arranged in a two-dimensional configuration, then as shown schematically in FIG. 2, the ejection electrodes 18 are arranged two-dimensionally so as to correspond to the respective ejection ports 28.

The ejection electrodes 18 are exposed to the liquid flow channel 30 and make contact with the bonding liquid Q flowing in the liquid flow channel 30. Consequently, it is possible significantly to improve the ejection characteristics of the bonding liquid droplets R. However, it is not absolutely necessary for the ejection electrodes 18 to be exposed to the liquid flow channel 30 and to make contact with the bonding liquid Q. In other words, the ejection electrodes 18 may be formed inside the ejection port substrate 16, and the exposed surfaces of the ejection electrodes 18 may be covered by a thin insulating layer, or the like.

The ejection electrodes 18 are connected to a control unit 33. The control unit 33 is able to control the voltage applied to the ejection electrodes 18 when ejecting and not ejecting bonding liquid Q.

The guard electrode 20 is formed on the surface of the insulating substrate 32, and the surface of the guard electrode 20 is covered with an insulating layer 34. FIG. 3 shows a schematic drawing of the planar structure of the guard electrode 20. FIG. 3 is a perspective view along arrow III-III in FIG. 1A, and it shows a schematic view of the planar structure of the guard electrode 20 in the case of a liquid ejection head having a multi-channel structure. As shown in FIG. 3, the guard electrode 20 is a sheet-shaped electrode constituted by a metal sheet, or the like, which is common to a plurality of ejection electrodes 18, and it has opening sections 36 provided in positions corresponding to the ejection electrodes 18 formed about the perimeter of the respective ejection ports 28, which are arranged in a two-dimensional configuration. The opening sections 36 are formed in a rectangular shape. The opening sections 36 in the guard electrode 20 are formed to a larger length and width than the length and width of the ejection ports.

The guard electrode 20 blocks off lines of electrical force between mutually adjacent ejection electrodes 18 and is thereby able to suppress electrical field interference. A prescribed voltage is applied to the guard electrode 20 (including a ground voltage of 0V). In the example illustrated, the guard electrode 20 is grounded to a voltage of 0V.

In a desirable mode, the guard electrode 20 is formed in a different layer to the ejection electrodes 18, as shown in FIG. 1A, and the whole surface thereof is covered with an insulating layer 34.

By providing the insulating layer 34 in this way, it is possible satisfactorily to prevent electrical field interference between mutually adjacent ejection electrodes 18, as well as being able to prevent discharge of the charged particles (reference numeral 60 in FIGS. 6A and 6B) of the bonding liquid Q, between the ejection electrodes 18 and the guard electrode 20.

Here, of the lines of electrical force generated by the ejection electrodes 18, the guard electrode 20 is required in order to preserve lines of electrical force acting on the corresponding ejection port 28 (below, referred to as “home channel” for the sake of convenience), while shielding lines of electric force from the ejection electrodes 18 provided for other ejection ports 28 (referred to as “other channels”) as well as protecting other channels from lines of electric force from the home channel in question.

If there is no guard electrode 20, then when ejecting bonding liquid Q, the lines of electric force generated from the end portions of the ejection electrode 18 on the side adjacent to the ejection port 28, (hereinafter, called the inner edges of the ejection electrode) are concentrated on the inside of the ejection electrode 18, in other words, in the region surrounded by the inner edge of the ejection electrode 18, and therefore act on the home channel, generating the electrical field necessary to eject bonding liquid Q. On the other hand, the lines of electrical force generated from the ends of the ejection electrode 18 on the side opposite to the ejection port 28 (hereinafter, called the outer edges of the ejection electrode) are dispersed outwards beyond the outer edges of the ejection electrode 18, thereby causing effects on other channels and giving rise to electrical field interference.

In view of these points, desirably, the width and the length of the square-shaped opening sections 36 in the guard electrode 20 are formed to be larger than the ejection electrode 18 of the home channel when the substrate is observed in plan view, in such a manner that the lines of electrical force acting on the home channel are not shielded. In other words, desirably, at each ejection port 28, the edge sections of the guard electrode 20 on the sides adjacent to the ejection port 28 are distanced (withdrawn) further from the ejection port 28, in comparison with the inner edges of the ejection electrode 18 of the home channel.

Furthermore, in order to effectively shield the lines of electric force from acting on other channels, desirably, the length and width of the rectangular-shaped opening sections 36 in the guard electrode 20 are smaller than the interval between the outer edges of the ejection electrode 18 in the home channel, when the substrate is observed in planar view. In other words, the inner edges of the guard electrode 20 desirably extend towards (advance towards) the ejection port 28, beyond the outer edges of the ejection electrode 18 at the home channel. The amount of this extension is desirably, 5 μm or greater, and more desirably, 10 μm or greater.

By adopting the composition described above, it is possible sufficiently to suppress variation in the deposition positions of the bonding liquid droplets R caused by electrical field interference between mutually adjacent channels, while sufficiently ensuring ejection stability of the ejection ports 28, and therefore stable high-quality supply of the bonding liquid can be achieved.

The opening sections 36 of the guard electrode 20 are formed to have a substantially similar shape to the form of the inner edges or outer edges of the ejection electrodes 18, and the guard electrode 20 may be provided in such a manner that, at each ejection port 28, the inner edges of the guard electrode 20 are distanced (withdrawn) from the ejection port 28 beyond the inner edges of the ejection electrode 18 of the home channel and are positioned closer to (advanced) the ejection port 28 in comparison with the outer edges of the ejection electrode 18 (in other words, the opening sections 36 may be formed in the guard electrode 20).

Furthermore, in the example described above, the guard electrode 20 is taken to be a sheet-shaped electrode, but the present invention is not limited to this, and it is possible to adopt any shape or structure provided that the guard electrode 20 is provided between the ejection ports 28 in such a manner that it can shield the lines of electric force from acting on the other channels. For example, the guard electrode 20 may also be provided in a mesh-shape between the ejection ports 28. Furthermore, in the case of a plurality of ejection ports 28 arranged in a matrix configuration, if the intervals between the ejection ports 28 which are mutually adjacent in the column direction and the row direction are different, it is possible to provide the guard electrode only between ejection ports 28 which are positioned close to each other, without providing the guard electrode between ejection ports 28 which are separated from each other by a sufficient distance to avoid the occurrence of electrical field interference.

In cases of this kind, with respect to the ejection electrode 18 of the home channel, the guard electrode 20 is formed in such a manner that at each ejection port 28, the inner edges of the guard electrode 20 are distanced from the ejection port 28 beyond the inner edges of the ejection electrode 18 of the home channel, but are positioned closer to the ejection port 28 than the outer edges of the ejection electrode 18.

Here, the shape of the opening sections 36 of the guard electrode 20 is approximately the same shape as that of the ejection ports 28, but the shape of the opening sections 36 is not limited to this, and it may be set to any desired shape, provided that the guard electrode 20 is capable of preventing electrical field interference by shielding the lines of electrical force between the mutually adjacent ejection electrodes 18. For example, it is possible to adopt a circular shape, an oval shape, a square shape, a rhomboid shape, or the like.

Moreover, a desirable mode of the liquid ejection head 10 according to the present embodiment is one in which liquid guide dams 40 are provided on the head substrate 12 in order to guide the bonding liquid Q to the ejection ports 28. Below, these liquid guide dams 40 are described.

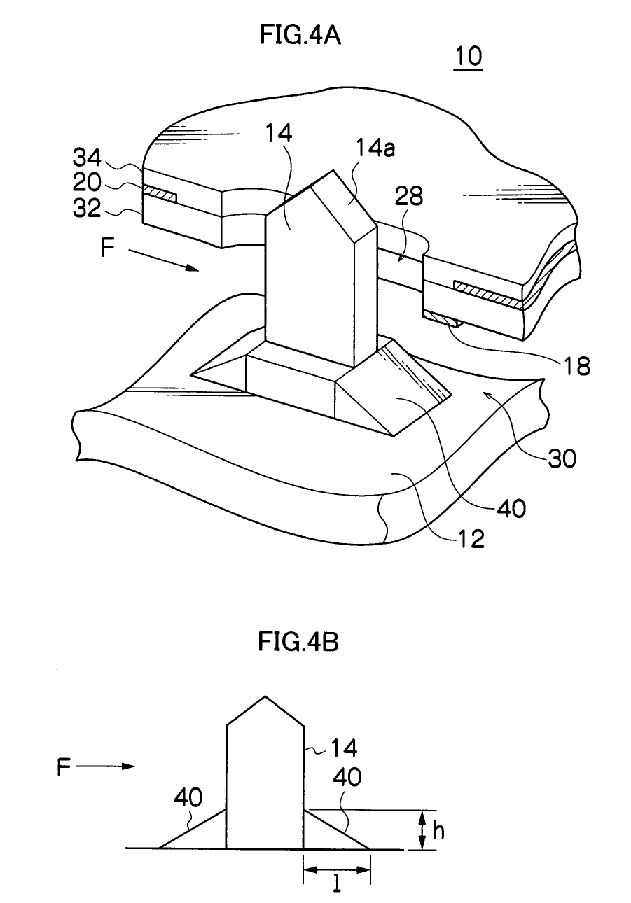

FIG. 4A is a partial cross-sectional perspective diagram showing the composition of the liquid ejection head 10 in FIGS. 1A and 1B in the vicinity of an ejection port 28. In FIG. 4A, in order to clarify the structure of the liquid guide dams 40, the ejection port substrate 16 is depicted in a cross-sectional view along the liquid flow direction F, at the substantially central position of a liquid guide 14.

The liquid guide dams 40 are provided on the surface of the head substrate 12 on the side adjacent to the liquid flow channel 30, in other words, the bottom face of the liquid flow channel 30, on both the upstream side and the downstream side, in terms of the liquid flow direction F, of each liquid guide 14, which is disposed in a position corresponding to an ejection port 28. The liquid guide dams 40 each have a surface inclined to gradually come closer to the ejection port substrate 16 from a position near the position corresponding to the ejection port 28 toward the position corresponding to the center of the ejection port 28. In other words, the liquid guide dams 40 have a shape which inclines toward the ejection port 28, in terms of the liquid flow direction F.

Furthermore, the liquid guide dams 40 have substantially the same width as the ejection ports 28 in the direction perpendicular to the liquid flow direction F, and have walls which rise up vertically from the bottom surface. Furthermore, the liquid guide dams 40 are provided at a prescribed interval from the surface of the ejection port substrate 16 on the side of the liquid flow channel 30, in other words, from the upper surface of the liquid flow channel 30, in such a manner that the flow path of the bonding liquid Q is guaranteed and the ejection port 28 is not blocked off. These Liquid guide dams 40 are provided respectively for the ejection ports 28.

In this way, by providing the liquid guide dams 40 which are inclined towards the ejection ports 28 in the liquid flow direction F, on the bottom surface of the liquid flow channel 30, a liquid flow toward the ejection ports 28 is formed and the bonding liquid Q is directed toward the opening sections of the ejection ports 28 on the side adjacent to the liquid flow channel 30. Therefore, it is possible to cause the bonding liquid Q to flow appropriately into the ejection ports 28, and hence the supply of the particles in the bonding liquid Q is improved further. Moreover, it is also possible to prevent blockages more reliably.

The length l of each liquid guide dam 40 in the liquid flow direction F should be set appropriately in such a manner that the bonding liquid Q can be guided suitably to the ejection ports 28, without interfering with adjacently positioned ejection ports 28, but as shown in FIG. 4B, desirably, it is 3 or more times, and more desirably, 8 or more times, the height h of the highest portion of each liquid guide dam 40 (in other words, desirably, l/h≧3, and more desirably, l/h≧8).

The width of the liquid guide dams 40 in the direction perpendicular to the liquid flow direction F is desirably equal to or slightly broader than the ejection ports 28. Furthermore, the width of the liquid guide dams 40 is not limited to being a uniform width as in the drawings, and the liquid guide dams 40 may also decrease gradually in width or increase gradually in width, or the like. Moreover, the wall surfaces of the liquid guide dams 40 are not limited to being vertical surfaces, and they may also be inclined surfaces, or the like.

The inclined surfaces of the liquid guide dams 40 (the surfaces which guide the liquid) should be formed to a suitable shape for guiding the bonding liquid Q toward the ejection ports 28, and they may be inclined surfaces having a uniform angle of inclination, or they may be surfaces having a variable angle of inclination, or curved surfaces. Furthermore, the front surface of the liquid guide dams 40 is not limited to being a smooth surface, and it is also possible to form one or more ridge or groove, or the like, in the liquid flow direction F, or in a radiating fashion toward the center of the ejection port 28.

Furthermore, the vicinity of the contact sections between the liquid guide 14 and the upper portions of the liquid guide dams 40 may be formed to a smoothly connected shape, rather than having a step difference as shown in the drawings.

In the example shown, liquid guide dams 40 are disposed on the upstream side and the downstream side of each liquid guide 14, but it is also possible to adopt a mode in which a trapezoid-shaped liquid guide dam 40 having an inclined surface on the upstream side and the downstream side of the ejection port 28 is provided, the liquid guide 14 being erected on top of this liquid guide dam 40, and it is also possible to form the liquid guide 14 and the liquid guide dam 40 in an integrated fashion. In this way, the liquid guide dams 40 may be formed separately from the liquid guides 14, or integrally with the liquid guides 14, or provided on the head substrate 12, or alternatively, they may be formed by cutting away the head substrate 12 by means of a commonly known excavation technique.

A liquid guide dam 40 should be provided on the upstream side of each ejection port 28, but it is desirable to provide a liquid guide dam 40 on the downstream side of the ejection port 28 as well, as shown in FIGS. 4A and 4B, in such a manner that the height in the ejection direction of the bonding liquid droplets R reduces gradually as the position moves away from the ejection port 28. Thereby, the bonding liquid Q guided toward the ejection port 28 by the liquid guide dam 40 on the upstream side flows smoothly toward the downstream side, and consequently, there is no disturbance of the flow of bonding liquid Q, and it is possible to ensure the stability of the liquid flow and to ensure stable ejection characteristics.

Furthermore, in the example in FIGS. 4A and 4B, the liquid guide dams 40 are disposed on the upper surface of the head substrate 12, but the composition is not limited to this and it is also possible to provide a liquid flow groove in the head substrate 12 and provide a liquid guide dam inside the liquid flow groove.

For example, a liquid flow groove of a prescribed depth is provided passing through a position corresponding to the ejection port 28, following the liquid flow direction F, and a liquid guide dam having a surface which is inclined toward the ejection port 28 is provided in the liquid flow direction F, at a position corresponding to the ejection port 28. By providing a liquid flow groove in this way, it is possible to cause a large amount of the bonding liquid Q flowing in the liquid flow channel 30 to flow selectively in the liquid flow groove, and by providing the liquid guide dam, the bonding liquid Q is caused to flow satisfactorily into the ejection port 28, and the supply of bonding liquid Q to the front end portion 14a can be improved.

As shown in FIG. 1A, a substrate holding section 24 is provided so as to oppose the surface (the ejection surface) of the liquid ejection head 10 from which the bonding liquid droplets R are ejected.

The substrate holding section 24 is disposed in a position opposing the front end portion 14a of the liquid guide 14, and is constituted by an earthed electrode substrate 24a, and an insulating sheet 24b which is disposed on the front surface of the electrode substrate 24a, which is on the lower side in FIG. 1A, in other words, on the surface adjacent to the liquid ejection head 10.

The electronic circuit substrate P is held on the surface of the substrate holding section 24 (the lower side in FIG. 1A), in other words, on the surface of the insulating sheet 24b, by means of electrostatic attraction, for example, and the substrate holding section 24 (insulating sheet 24b) functions as a platen for the electronic circuit substrate P.

When supplying bonding liquid Q, at least, the electronic circuit substrate P held on the insulating sheet 24b of the substrate supporting section 24 is charged by the charging unit 26 to a prescribed high negative voltage, which is of opposite polarity to the drive voltage applied to the ejection electrode 18.

Consequently, the electronic circuit substrate P becomes negatively charged and is biased to a high negative voltage, and effectively, it practically acts as an opposing electrode with respect to the ejection electrode 18, as well as being electrostatically attracted to the insulating sheet 24b of the substrate holding section 24.

The charging unit 26 comprises a scorotron charger 26a for charging the electronic circuit substrate P to a high negative voltage, and a bias voltage source 26b which supplies a high negative voltage to the scorotron charger 26a. The charging device of the charging unit 26 used in the present invention is not limited to being the scorotron charger 26a, and it is also possible to use various types of charging devices, such as a corotron charger, a solid state charger, a discharge pin, or the like.

Furthermore, in the example illustrated, the substrate holding section 24 is constituted by an electrode substrate 24a and an insulating sheet 24b, and the electronic circuit substrate P is charged to a high negative voltage by means of the charging unit 26, thereby applying a bias voltage and causing the electronic circuit substrate P to act as an opposing electrode, while the electronic circuit substrate P is attracted electrostatically to the surface of the insulating sheet 24b; however, the present invention is not limited to this, and it is also possible to compose the substrate holding section 24 from an electrode substrate 24a only, and to connect the substrate holding section 24 (the electrode substrate 24a itself) to a bias voltage source having a high negative voltage, thereby setting the substrate holding section 24 to a permanent high negative voltage bias, in such a manner that the electronic circuit substrate P is electrostatically attracted to the surface of the electrode substrate 24.

Furthermore, it is also possible to create electrostatic attraction of the electronic circuit substrate P to the substrate holding section 24, and to charge the electronic circuit substrate P to a high negative voltage or to apply a high negative bias voltage to the substrate holding section 24, by means of separate high negative voltage sources, and furthermore, the mechanism for holding the electronic circuit substrate P on the substrate holding section 24 is not limited to electrostatic attraction of the electronic circuit substrate P, and it is also possible to use another holding method or holding device.

Below, an embodiment of the present invention is described in more detail, by describing the action of ejecting the bonding liquid in the liquid ejection head 10.

As shown in FIG. 1A, in the liquid ejection head 10, during supply of the bonding liquid Q, the bonding liquid Q which contains charged particles (60 in FIGS. 6A and 6B) (described hereinafter) charged to the same polarity as the voltage applied to the ejection electrodes 18, for example, charged to a positive (+) voltage, is circulated inside the liquid flow channel 30 in the direction of the arrows F (the left to right direction in FIG. 1A), by means of a liquid circulation mechanism including a pump (not illustrated), and the like.

On the other hand, during the supply of the bonding liquid Q, the electronic circuit substrate P is supplied to the substrate holding section 24 and is charged to a high voltage of the opposite polarity to the charged particles, in other words, a high negative voltage (for example, −1500V), by means of the charging unit 26, thereby charging the electronic circuit substrate P with a bias voltage and attracting the substrate electrostatically to the substrate holding section 24.

In this state, control is implemented in such a manner that pulse voltages (hereinafter, called “drive voltage”) are applied to the ejection electrodes 18 by the control unit 33 in accordance with the supplied electronic circuit substrate manufacturing data, while the electronic circuit substrate P (substrate holding section 24) and the liquid ejection head 10 are moved relatively with respect to each other. Basically, by switching ejection on and off by turning the application of the drive voltage on and off, the ejection of the bonding liquid droplets R is modulated in accordance with the electronic circuit substrate manufacturing data, and the bonding liquid is thereby supplied to the lands of the electronic circuit substrate P.

Here, in a state where no drive voltage is applied to an ejection electrode 18 (or a state where the applied voltage is a low voltage level), in other words, a state where only a bias voltage is applied, forces such as the following act on the bonding liquid Q: a Coulomb attraction caused by the bias voltage and the charge of the charged particles of the bonding liquid Q, a Coulomb repulsive force between the charged particles, the viscosity and surface tension of the carrier liquid, the dielectric polarization force, and the like. Due to this combination of forces, the charged particles and carrier liquid are caused to move, and as shown in the schematic drawing in FIG. 1A, the forces are balanced by means of the bonding liquid Q in which a meniscus shape where it mounds out slightly from the ejection port 28.

Furthermore, the charged particles aggregate in the ejection port 28 due to the electrical field generated from the ejection electrode 18. Due to the Coulomb attraction force described above, and the like, the charged particles move toward the electronic circuit substrate P, which is charged with a bias voltage, in a so-called “electrical migration” effect. Consequently, in the meniscus formed at the ejection port 28, the bonding liquid Q assumes a condensed state.

From this state, a drive voltage is applied to the ejection electrode 18. Consequently, the drive voltage is superimposed on the bias voltage, and a movement is induced by this drive voltage being superimposed onto the combination of forces described above. An electrostatic force acts on the charged particles and the carrier liquid due to the electrical field generated by the application of the drive voltage to the ejection electrode 18. The charged particles and the carrier liquid are drawn towards the side of the bias voltage (the opposing electrode), in other words, towards the electronic circuit substrate P, due to this electrostatic force, and the meniscus formed at the ejection port 28 grows in the upward direction, thereby forming a so-called “Taylor cone”, which is a substantially circular cone-shaped liquid column extending above the ejection port 28. Furthermore, similarly to the foregoing, the charged particles move to the meniscus due to electrical migration, and the electrical field generated from the ejection electrode, and the bonding liquid Q becomes condensed at the meniscus, assuming a virtually uniform high-density state which contains a large number of charged particles.

When a further limited time period has elapsed after the start of application of the drive voltage to the ejection electrode 18, due to the movement of the charged particles, and the like, the balance between the forces acting principally on the charged particles (Coulomb force, and the like) and the surface tension of the carrier liquid, breaks down at the front end portion of the meniscus, where the electrical field intensity is high. Consequently, the meniscus extends suddenly and forms a long and narrow liquid column having a diameter of several μm to several ten μm, known as a “thread”.

As a further limited time period elapses, the thread grows, and the thread breaks due to the interaction between this growth of the thread, the vibration generated by Rayleigh/Weber instability, the loss of uniform distribution of the charged particles in meniscus, and the loss of uniform distribution of the electrostatic field applied to the meniscus. The broken thread is ejected in the form of a bonding liquid droplet R and flies toward the electronic circuit substrate P, in addition to which it is also pulled by the bias voltage and lands on the electronic circuit substrate P. The growth and breaking of the thread and the movement of the charged particles to the meniscus (thread) occur in a continuous fashion during the application of the drive voltage. Therefore, it is possible to adjust the ejection volume of the bonding liquid droplet R per pixel by adjusting the time during which the drive voltage is applied.

Furthermore, when the application of the drive voltage is ended (application switched off), the liquid returns to the state of the meniscus under the application of the bias voltage only.

Here, as shown in FIGS. 1A and 1B, the ejection ports 28 of the liquid ejection head 10 each have a long slit shape which is elongated in the liquid flow direction F. By forming the ejection ports 28 to have an elongated slit shape in this way, in other words, a shape having an aspect ratio equal to or greater than 1 between the length in the liquid flow direction F and the length in the direction perpendicular to the liquid flow direction F, the bonding liquid Q is more liable to flow into the ejection ports 28 and the supply of particles of the bonding liquid Q to the ejection port 28 is good. Consequently, it is possible to improve the supply of the particles in the bonding liquid Q, to the front end 14a of the liquid guide. Consequently, the ejection frequency during supply of the bonding liquid is improved, and dots of a desired size can be formed stably, even if bonding liquid droplets R are deposited in a continuous fashion at high speed. Moreover, by making the aspect ratio of the ejection ports 28 equal to or greater than 1, then the flow of the bonding liquid Q becomes smoother and it is possible to prevent blockage of the ejection ports 28.

Taking account of the image output time, it should be possible to eject droplets at an ejection frequency of 5 kHz, and more desirably, 10 kHz, and even more desirably, 15 kHz.

Here, more desirably, the ejection ports 28 have an aspect ratio between the liquid flow direction F and the direction perpendicular to same of 1.5 or greater.

By making the aspect ratio equal to or greater than 1.5, the supply of bonding liquid to the liquid guide 14 is improved further, and when forming large dots in a continuous fashion, it is possible to form dots in a more stable fashion, and the bonding liquid Q can be supplied at an even higher frequency.

Here, as described in the embodiment above, by forming the openings of the ejection ports 28 to have an aspect ratio equal to or greater than 1 between the length in the liquid flow direction F and the length in the direction perpendicular to the liquid flow direction F, it is possible to obtain the beneficial effects described above more satisfactorily, but the liquid ejection head according to the present invention is not limited to this, and by forming the openings of the ejection ports to have an aspect ratio of 1 or above between the long diameter and the short diameter of the opening, it is also possible to achieve a smooth flow of the bonding liquid Q and to prevent blockage of the ejection ports 28.

Furthermore, desirably, as in the present embodiment, the ejection electrodes 18 have a shape in which the portion on the upstream side in the liquid flow direction F is removed. By this means, no electrical field is created which impedes the inflow of charged particles to the ejection ports 28, from the upstream side in the liquid flow direction F, whereby the charged particles can be supplied to the ejection ports 28 efficiently. Furthermore, by disposing a portion of each ejection electrode 18 on the downstream side in terms of the flow of bonding liquid, an electrical field is created in a direction such that the charged particles flowing into the ejection port 28 stay in the ejection port 28. In light of the foregoing, by forming the ejection electrodes with a shape where a portion is removed on the upstream side in the liquid flow direction F, it is possible further to improve the supply of particles to the ejection ports 28.

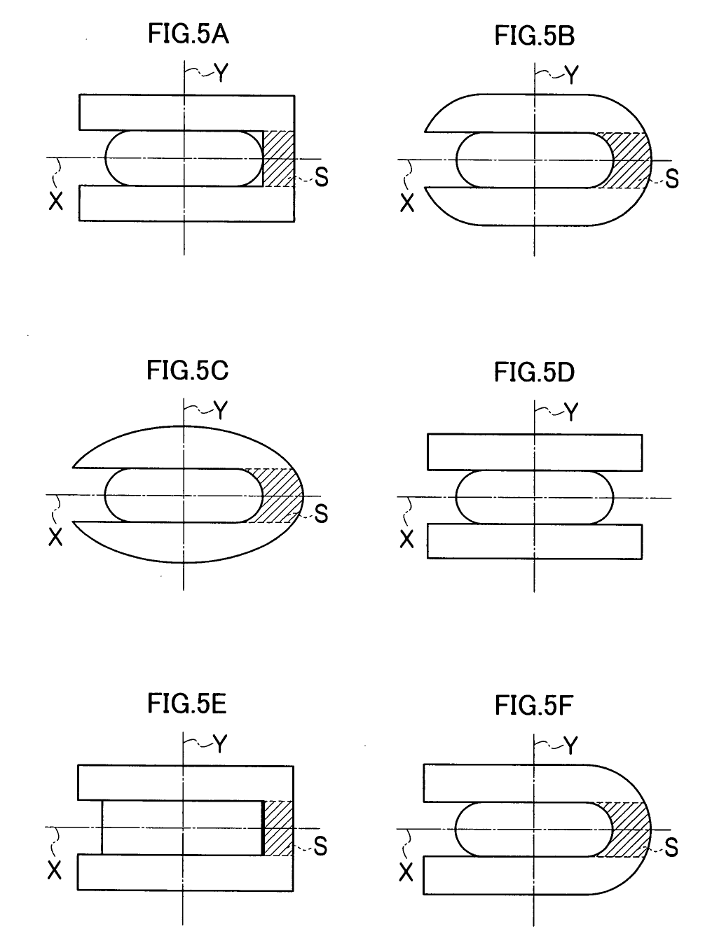

FIGS. 5A to 5F are schematic drawings showing various modes of an ejection electrode. Here, in FIGS. 5A to 5F, the bonding liquid Q flows in the direction from left to right in the drawings.

As shown in FIG. 5A, the ejection electrode may be a square U shaped electrode in which the edge on the upstream side in terms of the flow of liquid is cut away, and furthermore, as shown in FIG. 5B, it may also be an elongated cocoon shape in which both shorter edges of a rectangular shape are formed with a semicircular shape, the portion on the upstream side in terms of the flow of liquid being cut away. Moreover, as shown in FIG. 5C, for example, the ejection electrode may be an oval shape having a long axis parallel to the liquid flow direction F in which the portion on the upstream side in terms of the flow of liquid is cut away. Furthermore, as shown in FIG. 5D, it is also appropriate to use a parallel electrode in which rectangular electrodes are disposed in parallel with the longer diameter direction of the ejection port. In this way, by forming the ejection electrode to be symmetrical with respect to the plane that is parallel to the longitudinal direction of the ejection port and passes through the center of the ejection port, as shown in FIGS. 5A to 5D (the plane indicated by the line X in FIGS. 5A to 5D), and by forming the ejection electrode to have a shape in which the lengthwise portions of the ejection electrode, in other words, the portions apart from the shaded portion S in the case of the ejection electrodes shown in FIG. 5A, FIG. 5B and FIG. 5C, and the whole of the ejection electrode in the case of the ejection electrode shown in FIG. 5D, are symmetrical with respect to the plane that is parallel to the direction perpendicular to the long diameter direction of the ejection port and passes through the center of the ejection port (the plane indicated by the line Y in FIGS. 5A to 5D), then it is possible to stabilize the deposition positions of the bonding liquid droplets R. Furthermore, the ejection electrodes shown in FIGS. 5A to 5D have a shape in which a portion on the upstream side in terms of the liquid flow is cut away, and therefore it is possible to improve the supply of particles to the ejection port 28, as described previously.

The shape of the ejection ports is not limited to a long and thin cocoon shape, provided that the aspect ratio between the longer diameter and the shorter diameter of the opening is equal to or greater than 1, and as shown in FIG. 5E, in the case of a rectangular-shaped ejection electrode also, similarly to the foregoing description, by forming the ejection electrode to be symmetrical with respect to the plane that is parallel to the lengthwise direction of the ejection port and passes through the center of the ejection port (the plane indicated by the line X in FIG. 5E), and moreover, by forming the lengthwise portions of the ejection electrode (in FIG. 5E, the portions apart from the shaded portion S) to a shape which is symmetrical with respect to the plane that is perpendicular to the long diameter direction and passes through the center of the ejection port (the plane indicated by the line Y in FIG. 5E), then it is possible to stabilize the ejection positions of the bonding liquid droplets R.

The long diameter direction of the ejection port is not limited to a direction that is parallel to the liquid flow direction, and the long diameter direction of the ejection port may be set in any direction. By making the shape of the ejection electrode symmetrical with respect to the plane that is parallel to the long diameter direction of the ejection port and passes through the center of the ejection port, in accordance with the shape of the opening of the ejection port, and by forming the lengthwise portions of the ejection electrode to a shape which is symmetrical with respect to the plane that is perpendicular to the long diameter direction of the ejection and passes through the center of the ejection port, it is possible to stabilize the ejection positions of the bonding liquid droplets R.

Furthermore, from the viewpoint of enabling an electrical field that is substantially symmetrical with respect to the ejection port to be created readily, it is desirable that the shape of the ejection electrode should be symmetrical with respect to the plane that is parallel to the long diameter direction of the ejection port and passes through the center of the ejection port, and that the lengthwise portions of the ejection electrode should form a symmetrical shape with respect to the plane that is perpendicular to the long diameter direction of the ejection port and passes through the center of the ejection port; however, the shape of the ejection electrode is not limited to this. It is sufficient that the effective portion of the ejection electrode which contributes to ejection of bonding liquid droplets R should be substantially symmetrical with respect to the ejection port. For example, as shown in FIG. 5F, even if the ejection electrode has a square shape on the upstream side in terms of the liquid flow and a semi-circular U shape on the downstream side in terms of the liquid flow, and if the lengthwise portions (the portions apart from the shaded portion S in FIG. 5F) have a shape which is not symmetrical with respect to the plane that is perpendicular to the long diameter direction of the ejection port and passes through the center of the ejection port (the plane indicated by the line Y in FIG. 5F), then an electrical field which is substantially symmetrical with respect to the ejection port, in other words, an electrical field substantially having point symmetry with respect to the center of the ejection port or an electrical field which is substantially symmetrical with respect to the plane that is perpendicular to the long diameter direction of the ejection port and passes through the center of the ejection port, is still formed, and therefore stable ejection positions can be achieved for the bonding liquid droplets R.

Furthermore, in each of the cases shown in FIGS. 5A to 5F, the ejection electrodes are formed with a cutaway shape, but the shape of the ejection electrodes is not limited to this, and it is also possible to achieve stable ejection positions for the bonding liquid droplets R by using a circular electrode, an elliptical electrode, or a rectangular electrode, for instance, which is not formed with a cutaway section, and by forming the effective portion of the ejection electrode which contributes to ejection of the bonding liquid droplets R to a shape which is substantially symmetrical with respect to the ejection port, and desirably a shape which is symmetrical with respect to the plane that is parallel to the long diameter direction of the ejection port and passes through the center of the ejection port, as well as forming the lengthwise portions of the ejection electrode to a shape which is symmetrical with respect to the plane that is perpendicular to the long diameter direction of the ejection port and passes through the center of the ejection port.

Moreover, the shape of the ejection electrodes is not limited to the shapes described above. It is also possible to achieve stable ejection positions for the bonding liquid droplets R, by forming each ejection electrode to a shape which is symmetrical with respect to the plane that is parallel to the long diameter direction and passes through the center of the ejection port, in which the lengthwise portions of the ejection electrode formed in the long diameter direction of the ejection port are longer than the length of the ejection port in the long diameter direction; by forming the ejection electrode to a shape which is symmetrical about the line that is parallel to the long diameter direction and passes through the center of the ejection port, in which the centers of the lengthwise portions formed in the long diameter direction of the ejection port are located in the plane that is perpendicular to the long diameter direction and passes through the center of the ejection port; or by forming the ejection electrode to a shape which is symmetrical with respect to the plane that is parallel to the long diameter direction and passes through the center of the ejection port, in which the centers of the lengthwise portions formed in the long diameter direction of the ejection port are located in the plane that is perpendicular to the long diameter direction and passes through the center of the ejection port.

Furthermore, in the present embodiment, the ejection port desirably has an aspect ratio of 1 or greater between the long diameter and the short diameter of the opening, but the invention is not limited to a case of this kind, and it is also possible for the aspect ratio to be less than 1.

Furthermore, in the liquid ejection head 10 shown in FIGS. 1A and 1B, the ejection electrodes 18 are exposed to the liquid flow channel 30. In other words, the ejection electrodes 18 make contact with the bonding liquid Q in the liquid flow channel 30.

When a drive voltage is applied (ejection on) to an ejection electrode 18 which is in contact with the bonding liquid Q in the liquid flow channel 30 in this way, a portion of the electrical charge supplied to the ejection electrode 18 is injected into the bonding liquid Q, thereby increasing the conductivity of the bonding liquid Q located between the ejection port 28 and the ejection electrode 18. Consequently, in the liquid ejection head 10 according to the present embodiment, when the drive voltage is applied to the ejection electrode 18 (ejection on), the bonding liquid Q assumes a state where a bonding liquid droplet R is more liable to be ejected (namely, the ejectability characteristics are improved).

Moreover, by applying a voltage of the same polarity as the charged particles, to a square U-shaped ejection electrode 18, when not ejecting, in other words, when no drive voltage is applied, then it is possible to inject charge into the bonding liquid Q and to further enhance the conductivity of the bonding liquid Q, even when ejection is not being performed; therefore, the charged particles floating in the bonding liquid Q flowing from the upstream side are collected and stayed more reliably in the ejection port 28, by means of the electrostatic force generated by the ejection electrode 18.

Next, the bonding liquid Q (liquid bonding material) used in the liquid ejection head 10 is described below.

The bonding liquid Q forming the liquid bonding material relating to an embodiment of the present invention is a liquid bonding material in which charged particles 60 as shown in FIG. 6A are dispersed in an insulating solvent (hereinafter, called “carrier liquid”). Here, the charged particles 60 are formed by coating particle-shaped metal material (metal particles 62) with an insulating resin material 64, and then charging the insulating resin material 64. As shown in FIG. 6A, the bonding liquid Q is not limited in particular to one in which one charged particle 60 is constituted by coating one metal particle 62 with the insulating resin material 64, and as shown in FIG. 6B, it is also possible to constitute one charged particle 60 by coating a plurality of metal particles 62 with the insulating resin material 64. In general, the bonding liquid Q contains a mixture of the charged particles 60 which each contain one metal particle 62 as shown in FIG. 6A and the charged particles 60 which each contain a plurality of metal particles 62 as shown in FIG. 6B.

In the present specification, a particle means a particle-shaped object which may have, for example, a spherical shape, a spheroidal shape, or an indeterminate shape.

Desirably, the carrier liquid is a dielectric liquid having a high electrical resistance (of 10⁹ Ω·cm or above, and more desirably, 10¹⁰ Ω·cm or above). If a carrier liquid having low electrical resistance is used, then electrical conduction may occur between mutually adjacent ejection electrodes 18, and therefore a carrier liquid of this kind is not suitable for the present invention.

Furthermore, the dielectric constant of the carrier liquid is desirably 5 or lower, and more desirably, 4 or lower, and even more desirably, 3.5 or lower. It is desirable to set the dielectric constant of the carrier liquid to this range, in order that the electrical fields act effectively on the charged particles 60 in the carrier liquid.

Desirable examples of a carrier liquid of this kind are: a straight chain or branched aliphatic hydrocarbon, an alicyclic hydrocarbon, an aromatic hydrocarbon, and halogen substitutes of these hydrocarbons, and silicone oils of these hydrocarbons, and the like. For example, it is possible to use, individually or in mixed fashion: hexane, heptane, octane, isooctane, decane, isodecane, decalin, nonane, dodecane, isododecane, cyclohexane, cyclooctance, cyclodecane, toluene, xylene, mesitylene, Isopar C, Isopar E, Isopar G. Isopar H, Isopar L, Isopar M (Isopar: product name of Exxon Mobil Corp.), Shellsol 70, Shellsol 71 (Shellsol: product name of Shell Oil Co.), Amsco OMS, Amsco 460 solvent (Amsco: product name of American Mineral Spirits Co.), KF-96L (manufactured by Shinetsu Silicone Co., Ltd.), and the like.

The metal particles 62 are made of metal material having a melting point equal to or less than approximately 250° C., for example, a melting point of approximately 180 to 230° C., and this melting point is extremely low compared to the material used to form the wiring pattern, including the lands on the electronic circuit substrate P (this material being gold, copper, or the like). Here, the “melting point” means the temperature at which the material in question starts to melt, at least partially.

The metal material used for the metal particles 62 may be, for example, a so-called solder material. The solder material may or may not contain lead, but taking account of the effects on the environment, it is desirable to use a lead-free solder material which does not contain lead.

More specifically, the metal material used for the metal particles 62 may be a metal material which is commonly known in the related art, such as an Sn—Pb material, an Sn—Ag material, an Sn—Ag—Cu material, an Sn—Bi material, an Sn—Cu material, an Sn—Cu—Ni material, an Sn—Ag—Bi material, an Sn—Ag—Bi—In material, an Sn—Ag—Bi—Cu material, an Sn—Zn material, an Sn—Zn—Bi material, or the like.

Here, a “ . . . material” of this kind desirably has a eutectic composition of the constituent elements, or a composition approximate to this, and it also refers to a material which may include other components in small amounts, provided that the composition does not deviate significantly from a eutectic composition.

The insulating resin material 64, which coats the metal particles 62, desirably has anti-oxidation properties and adhesive properties, and it is desirable to use rosin, for example.

Moreover, the insulating resin material 64 may be, for example, rosin particles, a rosin-modified phenol resin, an alkyd resin, a (meth)acrylic polymer, polyurethane, polyester, polyamide, polyethylene, polybutadiene, polystyrene, polyacetic vinyl, an acetal modification of a polyvinyl alcohol, polycarbonate, or the like.

In the bonding liquid Q, desirably, the content of the metal particles 60 (the total content of the metal particles 62 and the insulating resin material 64) is in the range of 10 to 70 wt % with respect to the total amount of the bonding liquid Q, and more desirably, it is in the range of 20 to 60 wt %. If the content of the charged particles 60 is low, then an insufficient amount of charged particles adheres to the supply points (lands) on the electronic circuit substrate P, and it is difficult to obtain affinity between the bonding liquid Q and the supply points (lands) on the electronic circuit substrate P, leading to problems in obtaining bonds of sufficient strength, and the like. On the other hand, if the content of the charged particles 60 is high, then it is difficult to obtain the bonding liquid Q including the charged particles 60 dispersed homogeneously, the liability of blockages in the liquid ejection head due to the bonding liquid Q is increased, and consequently it is difficult to achieve stable ejection of the liquid.

Furthermore, the average particle size of the charged particles 60 dispersed in the carrier liquid is desirably 0.1 to 5 μm, and more desirably 0.2 to 1.5 μm. This particle size was determined by means of a CAPA-500 instrument (product name, manufactured by Horiba Seisakusho (Co., Ltd.)).

After dispersing the charged particles 60 in a carrier liquid (a dispersant may also be used, if necessary), the charged particles 60 are charged by adding a charge controlling agent to the carrier liquid, thereby forming a bonding liquid Q in which the charged particles 60, which have received a charge, are dispersed in the carrier liquid.

For the charge control agent, for example, it is possible to use various agents which are employed in electrophotographic developing solutions. Furthermore, it is also possible to use various charge control agents described, for instance, in: “Recent development and application of electrophotographic developing systems and toner materials”, pp. 139 to 148; “Electrophotographic technology: Fundamentals and applications”, edited by Society of Electrophotography of Japan, pp. 497 to 505, (Corona, 1988); or “Electophotography” 16 (No. 2), p. 44 (1977), by Yuji Harazaki.

The charged particles 60 may be charged with either a positive charge or a negative charge, provided that their charge is of the same polarity as the drive voltage applied to the ejection electrodes 18.

Furthermore, the amount of charge on the charged particles 60 is desirably in the range of 5 to 200 μC/g, and more desirably, in the range of 10 to 150 μC/g.

Furthermore, the electrical resistance of the carrier liquid may also change with the addition of the charge control agent, and therefore the distribution ratio P defined below is desirably not less than 50%, and more desirably, not less than 60%.

P=100×(σ1−σ2)/σ1

Here, σ1 is the electrical conductivity of the bonding liquid Q, and σ2 is the electrical conductivity of the skimmed portion when the bonding liquid Q is placed in a centrifuge apparatus. The electrical conductivity was the value measured by using an LCR meter (AG-4311 manufactured by Ando Electric Co., Ltd.) and an electrode for ink (LP-05 manufactured by Kawaguchi Electric Works Co., Ltd.), under conditions of 5V applied voltage and 1 kHz frequency. Furthermore, centrifugal separation was carried out using a compact high-speed refrigerated centrifuge apparatus (SRX-201 manufactured by Tomy Seiko Co., Ltd.), for 30 minutes at a rotational speed of 14500 rpm and a temperature of 23° C.

By using the bonding liquid Q described above, migration of the charged particles 60 becomes more liable to occur and the particles can be concentrated more readily.

The electrical conductivity of the bonding liquid Q is desirably 100 to 3000 pS/cm, and more desirably, 150 to 2500 pS/cm. By setting the electrical conductivity to the range described above, the voltage applied to the ejection electrodes 18 does not become excessively high, and there are no concerns regarding the occurrence of electrical conduction between mutually adjacent ejection electrodes 18.

Furthermore, the surface tension of the bonding liquid Q is desirably in the range of 15 to 50 mN/m, and more desirably, in the range of 15.5 to 45 mN/m. By setting the surface tension to this range, the voltage applied to the control electrode does not become excessively high, and there is no spreading and leaking of bonding liquid Q about the periphery of the head.

Moreover, the viscosity of the bonding liquid Q is desirably 0.5 to 5 mPa·sec, and more desirably, 0.6 to 3.0 mPa·sec.

The ratio of the metal particles 62 in the charged particles 60 is set to a ratio at which conduction is achieved between the electrodes of the electronic circuit substrate P and the electrodes of the electronic components. Furthermore, the ratio of the insulating resin material 64 in the charged particles 60 is a ratio which allows the metal particles 62 to be coated sufficiently.

For example, with respect to 100 parts by weight of the metal particles (in other words, 100 parts by weight of metal material), the insulating resin material is present at a ratio of 5 to 30 parts by weight, and desirably, 15 to 25 parts by weight, the dispersion medium (carrier liquid) is present at a ratio of 100 to 1000 parts by weight, and desirably, 150 to 800 parts by weight, and the dispersant is present at a ratio of 20 to 80 parts by weight, and desirably, 30 to 70 parts by weight. The insulating resin material coats the metal particles, but a portion of the insulating resin material may also be dispersed independently in the dispersion medium (carrier liquid), or it may be dissolved in the dispersion medium.

The bonding liquid Q described above can be manufactured by coating metal particles 62 with a coating layer constituted substantially by the insulating resin material 64, by means of a surface fusion process (“surfusion”) or a mechanical surface treatment (mechanochemical reaction), using particles constituted by the insulating resin material, and then adding the particles obtained by the coating process and a dispersant to a dispersion medium (carrier liquid) and mixing it (for instance, mixing it at room temperature), and finally adding a charge control agent to the mixture.

Furthermore, the bonding liquid Q may also be manufactured by previously mixing (or kneading) together metal particles 62, resin particles constituted by an insulating resin material, a dispersant, and a portion of the dispersion medium (carrier liquid), then adding the remaining dispersion medium to the preparatory mixture thus obtained and mixing with same, and finally adding a charge control agent to the mixture.

In order to obtain a bonding liquid Q containing a dispersant, it is possible that the dispersant is mixed in combination when preparing the preparatory mixture, and it is also possible to add and mix further dispersant when the remaining dispersion medium (carrier liquid) is added to the mixture obtained by the preparatory mixing step. Furthermore, when obtaining a bonding liquid Q containing an antioxidant (or an oxide removing agent), it is possible to mix the antioxidant in combination when preparing the preparatory mixture. Moreover, if using an activating agent, such as adipic acid or stearic acid, as an antioxidant, then it is possible to pretreat the metal particles 62 with the activating agent of azipnic acid or stearic acid, or the like, before the preparatory mixing step.

The method of manufacturing the bonding liquid Q is not limited in particular, and the bonding liquid Q may be manufactured by means of any other suitable method.

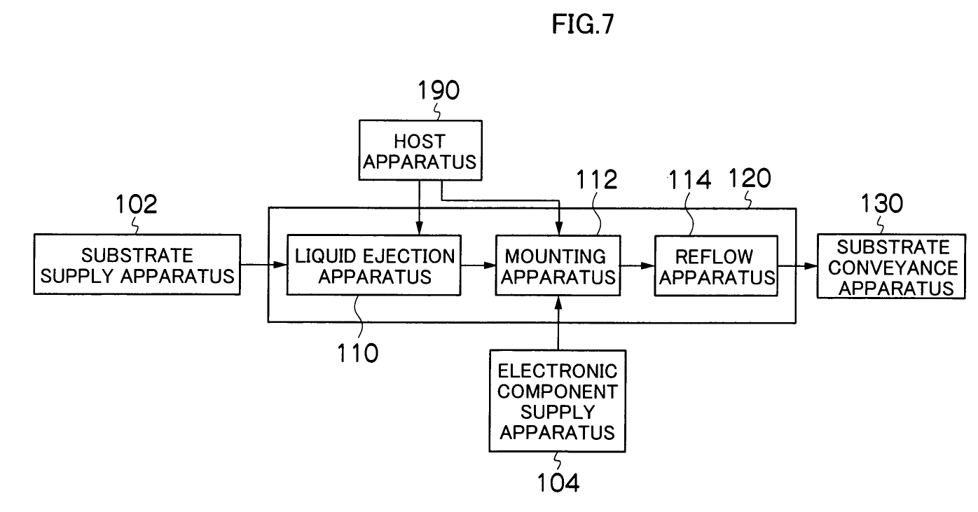

FIG. 7 is a block diagram showing one embodiment of a bonding apparatus 120 which comprises a liquid bonding material supply apparatus 110 (hereinafter, called “liquid ejection apparatus”) relating to an embodiment of the present invention, which includes the liquid ejection head 10 shown in FIGS. 1A and 1B.

In FIG. 7, the substrate supply apparatus 102 is an apparatus which supplies an electronic circuit substrate to the liquid ejection apparatus 110. The electronic component supply apparatus 104 is an apparatus which supplies electronic components to the mounting apparatus 112. The liquid ejection apparatus 110 includes the liquid ejection head 10 illustrated in FIGS. 1A and 1B, the substrate holding section 24, and the charging unit 26, and forms an apparatus for supplying the bonding liquid to prescribed locations on the electronic circuit substrate, on the basis of electronic circuit substrate manufacturing data output from a host apparatus 190. The mounting apparatus 112 (mounter) is an apparatus which arranges electronic components on an electronic circuit substrate to which bonding liquid Q has been supplied at prescribed locations, on the basis of electronic circuit manufacturing data output from the host apparatus 190. The reflow apparatus 114 causes the insulating material and the metal particles in the charged particles of the bonding liquid Q to melt, by subjecting the electronic circuit substrate on which the electronic components have been arranged to a heating process. The substrate conveyance apparatus 130 is an apparatus which conveys out an electronic circuit substrate to which electronic components have been bonded by means of the heating process. The host apparatus 190 outputs electronic circuit substrate manufacturing data and electronic circuit manufacturing data to the liquid ejection apparatus 110 and the mounting apparatus 112. Here, the electronic circuit substrate manufacturing data includes at least information (land position information) indicating the positions of the lands on the electronic circuit substrate.

In the present example, one bonding apparatus 120 includes the liquid ejection apparatus 110, the mounting apparatus 112, and the reflow apparatus 114.

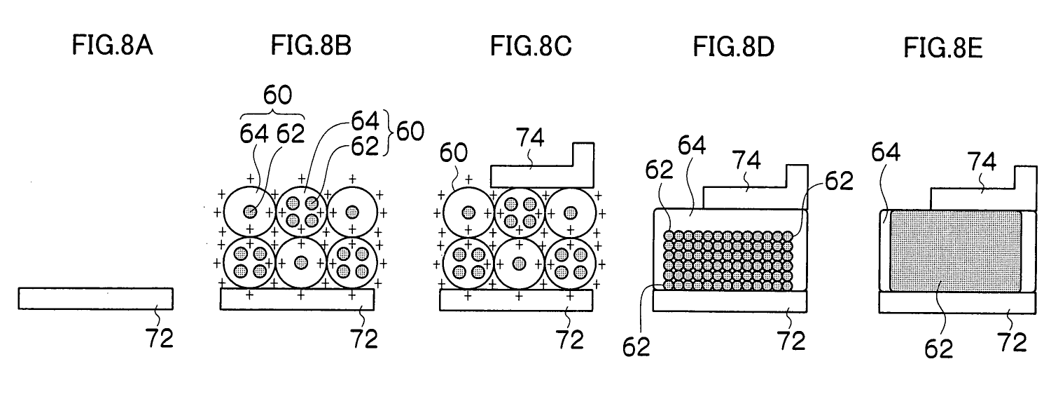

FIGS. 8A to 8E are process step diagrams used to describe a bonding process using the bonding apparatus 120 in FIG. 7. Below, the bonding process is described in detail with reference to FIG. 7 and FIGS. 8A to 8E.

Firstly, as shown in FIG. 8A, an electronic circuit substrate P formed with lands 72 is supplied to the liquid ejection apparatus 110, by means of the substrate supply apparatus 102 shown in FIG. 7.

Thereupon, using the liquid ejection apparatus 110 shown in FIG. 7, the bonding liquid Q is condensed by means of an electrostatic force generated between the liquid ejection apparatus 110 (and more specifically, the ejection electrodes 18 of the liquid ejection head 10 in FIGS. 1A and 1B) and the lands 72 of the electronic circuit substrate P, as shown in FIG. 8B, and the condensed bonding liquid Q is ejected toward the lands 72 of the electronic circuit substrate P, thereby supplying the bonding liquid Q to the lands 72 of the electronic circuit substrate P. More specifically, by generating an electrical field at an ejection port 28 by applying a drive voltage to an ejection electrode 18 of the liquid ejection head 10 in FIGS. 1A and 1B, the bonding liquid Q in the ejection port 28 is condensed due to the electrostatic force, and is deposited onto the land 72 shown in FIGS. 8A to 8E, in the form of a bonding liquid droplet R.

By ejecting the bonding liquid Q a plurality of times in a superimposed fashion onto the land 72 of the electronic circuit substrate P, the charged particles 60 are accumulated in layers on the land.

Here, the drive voltages applied to the ejection electrodes 18 of the liquid ejection head 10 are determined on the basis of the electronic circuit substrate manufacturing data, which includes at least the position information relating to the lands 72 on the electronic circuit substrate P, as supplied by the host apparatus 190. In other words, the ejection is performed onto the lands of the electronic circuit substrate P, on the basis of the electronic circuit substrate manufacturing data.

Desirably, charge is removed from the electronic circuit substrate P to which the bonding liquid Q has been supplied, in order to prevent damage to the electronic components as a result of static electricity in the subsequent steps.

Thereupon, as shown in FIG. 8C, the electrodes 74 of electronic components are arranged on the lands 72 of the electronic circuit substrate P, via the charged particles 60 accumulated in layers, by means of the mounting apparatus 112 shown in FIG. 7.

Thereupon, as shown in FIG. 8D, a first heating process is applied to the lands 72 of the electronic circuit substrate P, by means of the reflow apparatus 114 in FIG. 7, thereby causing the insulating resin material 64 of the charged particles 60 accumulated in layers on the lands 72 to melt. Here, the target temperature of the first heating process is lower than the melting point of the metal particles 62 and higher than the melting point of the insulating resin material 64. In so doing, the metal particles 62 aggregate on the lands 72 of the electronic circuit substrate P, and the molten insulating resin material 64 is separated to the periphery of the group of aggregated metal particles 62.

Thereupon, as shown in FIG. 8E, a second heating process is applied to the lands 72 of the electronic circuit substrate P, by means of the reflow apparatus 114 in FIG. 7, thereby causing the metal particles 62 on the lands 72 to melt. Here, target temperature of the second heating is higher than the melting point of the metal particles 62. After the second heating, the metal particles 62 are solidified by means of heat radiation and cooling. In so doing, the lands 72 of the electronic circuit substrate P and the electrodes 74 of the electronic components become bonded electrically and physically by means of the metal material 62.

In the method of manufacturing an electronic circuit substrate according to the present embodiment, since the bonding liquid Q is condensed (in other words, the ratio of carrier liquid is reduced and the ratio of charged particles 60 is increased) by means of an electrostatic force when the bonding liquid is ejected, a substantially solid component is supplied to the lands 72 of the electronic circuit substrate, and therefore the charged particles 60 are accumulated in layers without variation in the dot size in terms of the direction of accumulation, meaning that even in the case of very small lands 72, wetting and spreading of the bonding liquid Q on the lands 72 are prevented.

Furthermore, due to the electrostatic repulsion between the charged particles 60, the aggregation of particles in the bonding liquid Q is prevented and therefore good dispersion is obtained.

The bonding liquid Q according to the present embodiment is liquid at normal temperatures (5 to 50° C.), and therefore it is not necessary to carry out a heating process when supplying the bonding liquid Q. The consequences of this are, firstly, that high-temperature heating and heat radiation and cooling of the bonding liquid Q are not necessary before arranging (mounting) the electronic components, and secondly, the constituent materials of the liquid ejection head 10 are not required to have heat resistant properties. Therefore, costs are relatively low in comparison with a so-called solid ink type of bonding material, which requires heating to a high temperature (of 100 to 160° C.).

Moreover, in this case, a light irradiation step and a transfer step are not required and it is therefore possible to ensure size reduction, high productivity and reduced costs in the apparatus, in comparison with a case where the bonding material is supplied by means of an electrophotographic method which requires special steps for light illumination and transfer.

The foregoing description related to a liquid ejection apparatus 110 which ejects the bonding liquid Q by positively charging the charged particles in the bonding liquid Q, but the present invention is not limited to this and it is also possible to supply the bonding liquid Q from the liquid ejection apparatus which ejects the bonding liquid Q by negatively charging the charged particles in the bonding liquid Q.

Embodiments of the present invention have been described in detail above, but the present invention is not limited to the embodiments described above, and it is of course possible for improvements or modifications of various kinds to be implemented, within a range which does not deviate from the essence of the present invention.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A method of supplying a liquid bonding material, comprising the steps of:
preparing a liquid bonding material containing an insulating solvent and charged particles dispersed in the insulating solvent, the charged particles being constituted by metal particles and an insulating resin material that coats the metal particles and takes charge; and
condensing and supplying the liquid bonding material by means of an electrostatic force generated between a supply side and a supply receiving side for the liquid bonding material.

2. A method of manufacturing an electronic circuit substrate, comprising the steps of:
preparing a liquid bonding material containing an insulating solvent and charged particles dispersed in the insulating solvent, the charged particles being constituted by metal particles and an insulating resin material that coats the metal particles and takes charge;
condensing the liquid bonding material and supplying the liquid bonding material to a supply receiving location of a substrate, by means of an electrostatic force generated between a liquid supply apparatus supplying the liquid bonding material and the supply receiving location of the substrate by the liquid supply apparatus;
arranging an electrode of an electronic component on the supply receiving location of the substrate; and
causing the insulating resin material and the metal particles of the liquid bonding material supplied to the supply receiving location of the substrate to melt,
wherein the supply receiving location of the substrate and the electrode of the electronic component are bonded electrically and physically.

3. The method of manufacturing an electronic circuit substrate as defined in claim 2, wherein the supply receiving location of the substrate is a land of the substrate.

4. The method of manufacturing an electronic circuit substrate as defined in claim 3, wherein the liquid bonding material is ejected onto the land a plurality of times in such a manner that the charged particles are accumulated on the land.

5. The method of manufacturing an electronic circuit substrate as defined in claim 3, wherein the liquid bonding material is supplied to the land according to electronic circuit substrate manufacturing data which includes, at least, positional information relating to the land of the substrate.

6. A liquid bonding material supply apparatus which supplies a liquid bonding material to a supply receiving body, wherein:
the liquid bonding material contains an insulating solvent and charged particles dispersed in the insulating solvent, the charged particles being constituted by metal particles and an insulating resin material that coats the metal particles and takes charge; and
the liquid bonding material is condensed and supplied to the supply receiving body by means of an electrostatic force generated between the liquid bonding material supply apparatus and the supply receiving body.

7. A liquid bonding material which is condensed and supplied to a supply receiving side by means of an electrostatic force generated between a supply side and the supply receiving side, the liquid bonding material containing an insulating solvent and charged particles dispersed in the insulating solvent, the charged particles being constituted by metal particles and an insulating resin material that coats the metal particles and takes charge.

8. The liquid boding material as defined in claim 7, wherein the metal particles are made of a metal material selected from the group consisting of an Sn—Pb material, an Sn—Ag material, an Sn—Ag—Cu material, an Sn—Bi material, an Sn—Cu material, an Sn—Cu—Ni material, an Sn—Ag—Bi material, an Sn—Ag—Bi—In material, an Sn—Ag—Bi—Cu material, an Sn—Zn material, and an Sn—Zn—Bi material.

9. The liquid bonding material as defined in claim 7, wherein the insulating resin material includes at least one of an antioxidant component and an adhesive component.
